(19) United States
(12) Patent Application Publication
(10) Pub. No.: US 2018/0198645 A1
(43) Pub. Date: Jul. 12, 2018

(54) METHOD AND DEVICE FOR SUPPRESSING INTERFERENCE SIGNAL

(71) Applicant: DATANG MOBILE COMMUNICATIONS EQUIPMENT CO., LTD., Beijing (CN)

(72) Inventors: Xi WANG, Beijing (CN); Gang WU, Beijing (CN)

(21) Appl. No.: 15/742,034

(22) PCT Filed: Mar. 11, 2016
(86) PCT No.: PCT/CN2016/076159

§ 371 Date: Jan. 5, 2018

(30) Foreign Application Priority Data
Jul. 10, 2015 (CN) 201510405678.2

(51) Int. Cl. H04L 25/02; H04L 5/00; H04W 72/08; H04W 72/12

(52) U.S. Cl. CPC H04L 25/0202; H04L 5/0048; H04W 72/12; H04W 72/082; H04L 5/0073

(57) ABSTRACT

A method and device for suppressing an interference signal, the method comprising: performing signal reduction on a received signal of a given cell; performing channel estimation on the signal-reduced received signal of the given cell on the basis of a reference signal of the given cell and a reference signal of a neighboring cell to obtain a precise interference signal; and performing signal suppression on the precise interference signal. In the present application, before acquiring an interference signal, signal reduction is first performed on a received signal of a given cell, and then using a signal obtained by performing the signal reduction on the received signal of the given cell, estimation of interference is performed on the basis of scheduling information of a joint neighboring cell to acquire an accurate interference signal, achieving improved suppression of neighboring cell uplink co-channel interference.

### FIELD

The invention relates to the field of communications, in particular to a method and device for rejecting interference signal.

### BACKGROUND

In the Long Term Evolution (LTE) system, co-frequency networking is mostly adopted in actual network planning, thus co-frequency interference may occur in the system.

At present, an LTE receiver usually adopts the uplink Interference Rejection Combining (IRC) algorithm to suppress interference. The general IRC is as follows:

x=(H^{H}SH+C)⁻¹H^{H}Sy.

Where x is the equilibrium result; y is the antenna signal; H is the channel estimation result, S=Cₙ⁻¹, C=Cₓ⁻¹; Cₙ⁻¹ is the interference and noise covariance matrix of N_{R}×N_{R}; Cₓ⁻¹ is the transmit signal covariance matrix of N_{T}×T_{T}; N_{R} is the number of receiving antennas; N_{T} is the number of transmitting antennas.

The key to IRC is to obtain relatively precise channel estimation result H and Cₙ, and the general method for computing Cₙ is as follows:

$${C}_{n} = E [ {‖ r - {H}_{i} {s}_{i} ‖}_{2}^{2} ] = E [ {‖ \frac{r - {H}_{i} {s}_{i}}{{s}_{i}} ‖}_{2}^{2} ] = E [ {‖ \frac{r}{{s}_{i}} - {H}_{i} ‖}_{2}^{2} ] .$$

Where Sᵢ is the pilot sequence, and ∥Sᵢ∥=1.

Accordingly, Cₙ can be obtained based on the difference between the initial channel estimation result (receive signal r divided by pilot sequence Sᵢ) and the channel estimation result Hᵢ of the user i, namely, the initial channel estimation result deducted by the final channel estimation result of user i.

The channel estimation result Hᵢ of user i can generally be obtained through windows selection denoising of the initial channel estimation result.

If co-frequency interference from a neighboring cell exists in the data received, the pilot position of the transmitted signal of the user of a neighboring cell is also Zadoff sequence (i.e., Physical Random Access Channel sequence) which has favorable self-correlation and co-correlation, so interference is in a highly discrete state in the pilot symbol, and no precise channel estimation result H and Cₙ can be obtained from simple denoising based on the window.

Therefore, IRC is also improved through joint detection algorithm. Scheduling information of the neighboring cell is transmitted to the primary cell, channel estimation is performed on the received antenna signal in the primary cell using the cell parameters and scheduling information of the neighboring cell, and the channel estimation result of each user acquired finally is interference to the primary cell.

Due to the fine correlation property of the LTE uplink demodulation reference channel, compared with traditional IRC algorithm, the improved joint detection algorithm can acquire more precise channel estimation and interference detection results. However, in actual environment, signal of the current cell may be much higher than interference of the neighboring cell, so no precise interference can be calculated out by the adoption of the joint detection algorithm.

### SUMMARY

The application provides a method and device for rejecting interference signal to solve the problem that the interference acquired is not precise.

In order to solve the above problem, the application discloses a method for rejecting interference signal, including:

performing signal reduction on a received signal of a current cell;

performing channel estimation on the signal-reduced received signal of the current cell according to a reference signal of the current cell and a reference signal of a neighboring cell to obtain a precise interference signal; and

rejecting the precise interference signal.

Preferably performing channel estimation on the signal-reduced received signal of the current cell according to the reference signal of the current cell and the reference signal of the neighboring cell to obtain the precise interference signal includes:

performing channel estimation on the signal-reduced received signal of the current cell according to the reference signal of the current cell to obtain a rough interference signal; and

performing channel estimation on the rough interference signal according to the reference signal of the neighboring cell to obtain the precise interference signal.

Preferably performing channel estimation on the signal-reduced received signal of the current cell according to the reference signal of the current cell to obtain the rough interference signal includes:

obtaining the conjugate of the reference signal of the current cell, then multiplying with a pilot symbol of the signal-reduced received signal of the current cell to obtain a rough channel frequency-domain response with reference signal eliminated;

subjecting the rough channel frequency-domain response to inverse discrete Fourier transform to obtain a rough channel time-domain impulse response;

subjecting the rough channel time-domain impulse response to multi-user separation and windows selection denoising to obtain a rough single-user time-domain impulse response;

subjecting the rough single-user time-domain impulse response to discrete Fourier transform to obtain a rough channel estimation result of each user; and

subtracting the rough channel estimation result of each user from the rough channel frequency-domain response to obtain the rough interference signal.

Preferably performing channel estimation on the rough interference signal according to the reference signal of the neighboring cell to obtain the precise interference signal includes:

obtaining the conjugate of the reference signal of the neighboring cell, and multiplying with the rough interference signal to obtain a precise channel frequency-domain response with reference signal eliminated;

subjecting the precise channel frequency-domain response to inverse discrete Fourier transform to obtain a precise channel time-domain impulse response;

subjecting the precise channel time-domain impulse response to multi-user separation and windows selection denoising to obtain a precise single-user time-domain impulse response;

subjecting the precise single-user time-domain impulse response to Fourier transform to obtain a precise channel estimation result of the neighboring cell; and

subtracting the precise channel estimation result of the neighboring cell from the rough interference signal to obtain the precise interference signal.

Preferably rejecting the precise interference signal includes:

performing uplink Interference Rejection Combining detection using the precise interference signal to obtain a detection result; and

rejecting the precise interference signal according to the detection result.

The application also discloses a device for rejecting interference signal, including:

a signal reduction module configured to perform signal reduction on a received signal of a current cell;

a channel estimation module configured to perform channel estimation on the signal-reduced received signal of the current cell according to a reference signal of the current cell and a reference signal of a neighboring cell to obtain a precise interference signal; and

an interference rejection module configured to reject the precise interference signal.

Preferably the channel estimation module includes:

a rough interference signal acquisition module configured to perform channel estimation on the signal-reduced received signal of the current cell according to the reference signal of the current cell to obtain a rough interference signal; and

a precise interference signal acquisition module configured to perform channel estimation on the rough interference signal according to the reference signal of the neighboring cell to obtain the precise interference signal.

Preferably the rough interference signal acquisition module includes:

a rough channel frequency-domain response acquisition module configured to obtain the conjugate of the reference signal of the current cell, then multiply with a pilot symbol of the signal-reduced received signal of the current cell to obtain a rough channel frequency-domain response with reference signal eliminated;

a rough channel time-domain impulse response acquisition module configured to subject the rough channel frequency-domain response to inverse discrete Fourier transform to obtain a rough channel time-domain impulse response;

a rough single-user time-domain impulse response acquisition module configured to subject the rough channel time-domain impulse response to multi-user separation and windows selection denoising to obtain a rough single-user time-domain impulse response;

a rough channel estimation result acquisition module configured to subject the rough single-user time-domain impulse response to discrete Fourier transform to obtain a rough channel estimation result of each user; and

a rough interference signal acquisition module configured to subtract the rough channel estimation result of each user from the rough channel frequency-domain response to obtain the rough interference signal.

Preferably the precise interference signal acquisition module includes:

a precise channel frequency-domain response acquisition module configured to obtain the conjugate of the reference signal of the neighboring cell, then multiply with the rough interference signal to obtain a precise channel frequency-domain response with reference signal eliminated;

a precise channel time-domain impulse response acquisition module configured to subject the precise channel frequency-domain response to inverse discrete Fourier transform to obtain a precise channel time-domain impulse response;

a precise single-user time-domain impulse response acquisition module configured to subject the precise channel time-domain impulse response to multi-user separation and windows selection denoising to obtain a precise single-user time-domain impulse response;

a precise channel estimation result acquisition module configured to subject the precise single-user time-domain impulse response to Fourier transform to obtain a precise channel estimation result of the neighboring cell; and

a precise interference signal acquisition module configured to subtract the precise channel estimation result of the neighboring cell from the rough interference signal to obtain the precise interference signal.

Preferably the interference rejection module includes:

an interference detection module configured to perform uplink Interference Rejection Combining detection using the precise interference signal to obtain a detection result; and

a precise interference rejection module configured to reject the precise interference signal according to the detection result.

Compared with the background art, the invention has the following advantages.

Before obtaining the interference signal, the received signal of the current cell is subjected to signal reduction. Estimate is made to interference using the signal with the received signal of the current cell reduced according to the scheduling information of the neighboring cell to obtain a precise interference signal, which has a better rejection effect to the uplink co-frequency interference of the neighboring cell.

### BRIEF DESCRIPTION OF THE DRAWINGS

FIG. 1 is a flowchart of a method for rejecting interference signal in accordance with the first embodiment of the application;

FIG. 2 is a flowchart of a method for rejecting interference signal in accordance with the second embodiment of the application;

FIG. 3 is a structural diagram of a device for rejecting interference signal in accordance with the third embodiment of the application; and

FIG. 4 is the structural diagram of a device for rejecting interference signal in accordance with the fourth embodiment of the application.

### DETAILED DESCRIPTION

In order to make the objects, characteristics and advantages of the application more apparent and understandable, the present application will be described below in details with reference to the drawings and embodiments.

The method and device for rejecting interference signal in accordance with the application will be described in detail by some embodiments.

### First Embodiment

A method for rejecting interference signal in accordance with the embodiment of the application will be described in detail.

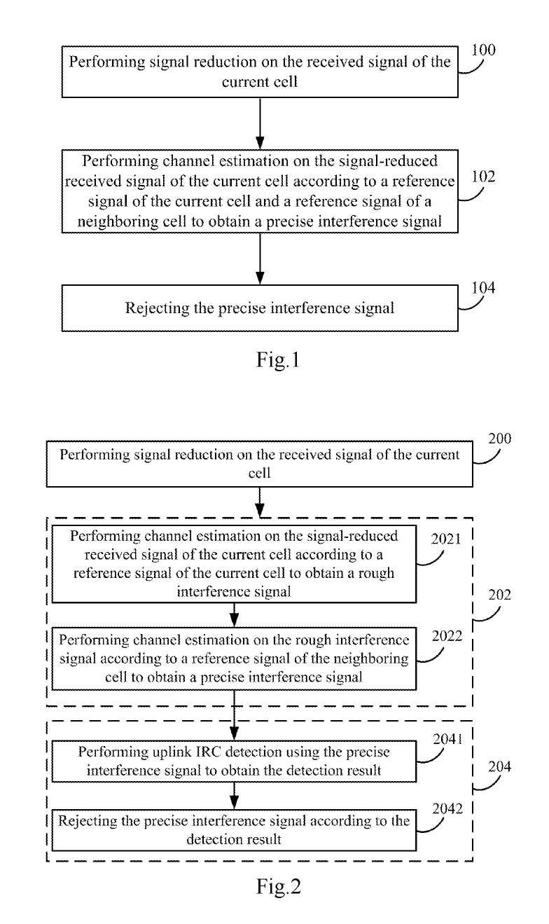

Referring to FIG. 1, the flowchart of a method for rejecting interference signal in accordance with the embodiment of the application is illustrated.

Step 100 is to perform signal reduction on the received signal of the current cell.

Interference from the received signal of the current cell is stronger than the interference from the neighboring cell, so the received signal of the current cell is subjected to signal reduction first.

Specifically, the standard or degree of reduction of the received signal of the current cell can be determined in view of actual conditions. The reduction of the received signal of the current cell will not be limited in the embodiment of the application.

Step 102 is to perform channel estimation on the signal-reduced received signal of the current cell according to a reference signal of the current cell and a reference signal of a neighboring cell to obtain a precise interference signal.

Scheduling information of the neighboring cell can be transmitted to the current cell, and the antenna signal received in the current cell can be subjected to channel estimation based on the cell parameter and scheduling information of the neighboring cell to obtain a precise interference signal. It needs to be noted that the precise interference signal is a more precise interference signal compared with the interference signal obtained in the prior art.

Step 104 is to reject the precise interference signal.

In conclusion, in the technical scheme of the application, before obtaining the interference signal, the received signal of the current cell is subjected to signal reduction. Estimate is made to interference using the signal with the received signal of the current cell reduced according to the scheduling information of the neighboring cell to obtain a precise interference signal, which has a better rejection effect to the uplink co-frequency interference of the neighboring cell.

### Second Embodiment

A method for rejecting interference signal in accordance with the embodiment of the application will be described in detail.

Referring to FIG. 2, the flowchart of a method for rejecting interference signal in accordance with the embodiment of the invention is illustrated.

Step 200 is to perform signal reduction on the received signal of the current cell.

Interference from the received signal of the current cell is stronger than the interference from the neighboring cell, so the received signal of the current cell is subjected to signal reduction first.

Specifically, the standard or degree of reduction of the received signal of the current cell can be determined in view of actual conditions. The reduction of the received signal of the current cell will not be limited in the embodiment of the application.

Step 202 is to perform channel estimation on the signal-reduced received signal of the current cell according to a reference signal of the current cell and a reference signal of a neighboring cell to obtain a precise interference signal.

Scheduling information of the neighboring cell can be transmitted to the current cell, and the antenna signal received in the current cell can be subjected to channel estimation based on the cell parameter and scheduling information of the neighboring cell to obtain a precise interference signal.

It should be noted that the above precise interference signal is a more precise interference signal compared with the interference signal obtained in the prior art.

Preferably, step 202 can include the following steps.

Step 2021 is to perform channel estimation on the signal-reduced received signal of the current cell according to a reference signal of the current cell to obtain a rough interference signal.

Preferably, step 2021 can include:

1) Obtaining the conjugate of the reference signal of the current cell, then multiplying with the pilot symbol of the signal-reduced received signal of the current cell to obtain a rough channel frequency-domain response with reference signal eliminated;

2) Subjecting the rough channel frequency-domain response to inverse discrete Fourier transform (IDFT) to obtain a rough channel time-domain impulse response.

3) Subjecting the rough channel time-domain impulse response to multi-user separation and windows selection denoising to obtain a rough single-user time-domain impulse response.

4) Subjecting the rough single-user time-domain impulse response to DFT to obtain the rough channel estimation result of each user.

5) Subtracting the rough channel estimation result of each user from the rough channel frequency-domain response to obtain the rough interference signal.

For example, the channel estimation result Hi of user i can generally be obtained through windows selection denoising of the initial channel estimation result. Specific steps are as follows.

Step 1: Obtaining the conjugate of the known reference signal r_{u,v}^{(α)}, then multiplying with the pilot symbol e_{freq,P}^{(k}^{_{αR}}^{,n}^{ₛ}⁾ to obtain the channel frequency-domain response e_{freq,ch}^{(k}^{_{αR}}^{, n}^{ₛ}⁾ with reference symbol eliminated.

Step 2: Subjecting e_{freq,ch}^{(k}^{_{αR}}^{, n}^{ₛ}⁾ to Inverse Discrete Fourier Transform (IDFT) to obtain the channel time-domain impulse response e_{time,ch}^{(k}^{_{αR}}^{, n}^{ₛ}⁾.

Step 3: Subjecting e_{time,ch}^{(k}^{_{αR}}^{, n}^{ₛ}⁾ to multi-user separation and windows selection denoising to obtain the single-user time-domain impulse response e_{time,ch}^{(k}^{_{αR}}^{, k}^{_{UE}}^{,n}^{ₛ}⁾ after windows selection denoising.

Step 4: Subjecting e_{time,ch}^{(k}^{_{αR}}^{, k}^{_{UE}}^{,n}^{ₛ}⁾ to Discrete Fourier Transform (DFT) to obtain the channel estimation result H^{(k}^{_{αR}}^{, k}^{_{UE}}^{,n}^{ₛ}⁾ of each user.

Step 5: e_{freq,ch}^{(k}^{_{αR}}^{, n}^{ₛ}⁾−H^{(k}^{_{αR}}^{, k}^{_{UE}}^{, n}^{ₛ}⁾ to obtain the rough interference signal I_{freq,ch}^{(k}^{_{αR}}^{, n}^{ₛ}⁾.

Step 2022 is to perform channel estimation on the rough interference signal according to a reference signal of the neighboring cell to obtain a precise interference signal.

Preferably, step 2022 can include:

6) Obtaining the conjugate of the reference signal of the neighboring cell, then multiplying with the rough interference signal to obtain a precise channel frequency-domain response with reference signal eliminated.

7) Subjecting the precise channel frequency-domain response to IDFT to obtain a precise channel time-domain impulse response.

8) Subjecting the precise channel time-domain impulse response to multi-user separation and windows selection denoising to obtain a precise single-user time-domain impulse response.

9) Subjecting the precise single-user time-domain impulse response to Fourier transform to obtain the precise channel estimation result of the neighboring cell.

10) Subtracting the precise channel estimation result of the neighboring cell from the rough interference signal to obtain the precise interference signal.

For example, the process of performing channel estimation on the rough interference signal according to a reference signal of the neighboring cell to obtain a precise interference signal specifically includes the following steps.

Step 6: Obtaining the conjugate of the the known neighboring cell r′_{u,v}^{(α)}, then multiplying with the rough interference signal I_{freq,ch}^{(k}^{_{αR}}^{,n}^{ₛ}⁾ to obtain the channel frequency-domain response e′_{freq,ch}^{(k}^{_{αR}}^{, n}^{ₛ}⁾ with reference symbol eliminated.

Step 7: Subjecting e′_{freq,ch}^{(k}^{_{αR}}^{, n}^{ₛ}⁾ to IDFT to obtain the channel time-domain impulse response e′_{time,ch}^{(k}^{_{αR}}^{, n}^{ₛ}⁾.

Step 8: Subjecting e′_{time,ch}^{(k}^{_{αR}}^{, n}^{ₛ}⁾ to multi-user separation and windows selection denoising to obtain the single-user time-domain impulse response e′_{time,ch}^{(k}^{_{αR}}^{, k}^{_{UE}}^{,n}^{ₛ}⁾ after windows selection denoising.

Step 9: Subjecting e′_{time,ch}^{(k}^{_{αR}}^{, k}^{_{UE}}^{,n}^{ₛ}⁾ to DFT to obtain the channel estimation result H′^{(k}^{_{αR}}^{, k}^{_{UE}}^{,n}^{ₛ}⁾ of the user of the neighboring cell.

Step 10: I_{freq,ch}^{(k}^{_{αR}}^{,n}^{ₛ}⁾−H′^{(k}^{_{αR}}^{, k}^{_{UE}}^{,n}^{ₛ}⁾ to obtain the precise interference signal I′_{freq,ch}^{(k}^{_{αR}}^{, n}^{ₛ}⁾.

It should be noted that the rough interference signal set forth in step 2021 is rough as compared with the precise interference signal set forth in step 2022, and the precise interference signal and the rough interference signal are relative.

In a similar way, the rough signal and the precise signal set forth in 1)-10) are also relative.

Step 204 is to reject the precise interference signal.

Preferably, step 204 can include the following steps.

Step 2041 is to perform uplink IRC detection using the precise interference signal to obtain the detection result.

The precise interference signal obtained is subjected to IRC detection to obtain the detection result.

Step 2042 is to reject the precise interference signal according to the detection result.

In conclusion, in the technical scheme of the application, before obtaining the interference signal, the received signal of the current cell is subjected to signal reduction. Estimate is made to interference using the signal with the received signal of the current cell reduced according to the scheduling information of the neighboring cell to obtain a precise interference signal, which has a better rejection effect to the uplink co-frequency interference of the neighboring cell.

### Third Embodiment

A device for rejecting interference signal in accordance with the embodiment of the application will be described in detail.

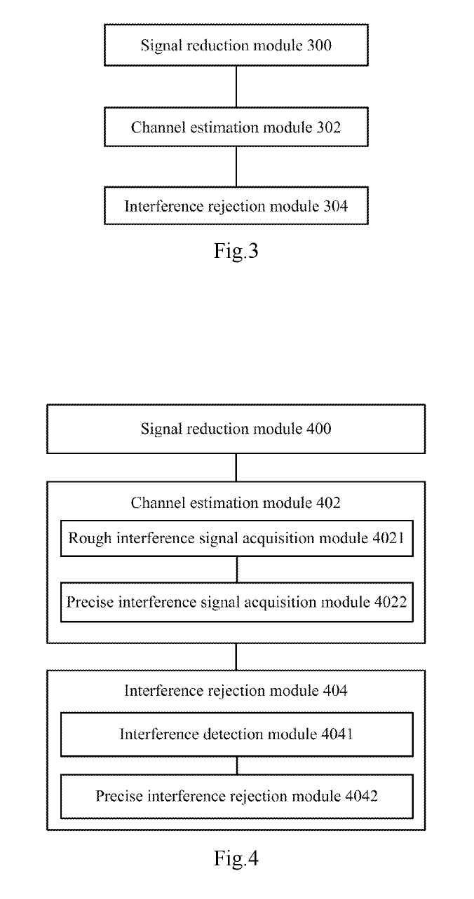

Referring to FIG. 3, the structural diagram of a device for rejecting interference signal in accordance with the embodiment of the invention is illustrated.

The device can include: a signal reduction module 300, a channel estimation module 302, and an interference rejection module 304.

Functions of each module and relationship between the modules will be introduced respectively in detail below.

The signal reduction module 300 is configured to perform signal reduction on the received signal of the current cell.

The channel estimation module 302 is configured to perform channel estimation on the signal-reduced received signal of the current cell according to a reference signal of the current cell and a reference signal of the neighboring cell to obtain a precise interference signal.

It should be noted that the precise interference signal is a more precise interference signal compared with the interference signal obtained in the prior art.

The interference rejection module 304 is configured to reject the precise interference signal.

In conclusion, in the technical scheme of the application, before obtaining the interference signal, the received signal of the current cell is subjected to signal reduction. Estimate is made to interference using the signal with the received signal of the current cell reduced according to the scheduling information of the neighboring cell to obtain a precise interference signal, which has a better rejection effect to the uplink co-frequency interference of the neighboring cell.

### Fourth Embodiment

A device for rejecting interference signal in accordance with the embodiment of the application will be described in detail.

Referring to FIG. 4, the structural diagram of a device for rejecting interference signal in accordance with the embodiment of the application is illustrated.

The device can include: a signal reduction module 400, a channel estimation module 402, and an interference rejection module 404.

The channel estimation module 402 can include a rough interference signal acquisition module 4021 and a precise interference signal acquisition module 4022.

The interference rejection module 404 can include an interference detection module 4041 and a precise interference rejection module 4042.

Functions of each module and relationship between the modules will be introduced respectively in detail below.

The signal reduction module 400 is configured to perform signal reduction on the received signal of the current cell.

The channel estimation module 402 is configured to perform channel estimation on the signal-reduced received signal of the current cell according to a reference signal of the current cell and a reference signal of the neighboring cell to obtain a precise interference signal.

It should be noted that the precise interference signal is a more precise interference signal compared with the interference signal obtained in the prior art.

Preferably, the channel estimation module 402 can include:

A rough interference signal acquisition module 4021 configured to perform channel estimation on the signal-reduced received signal of the current cell according to a reference signal of the current cell to obtain a rough interference signal.

Preferably, the rough interference signal acquisition module 4021 can include the following modules.

A rough channel frequency-domain response acquisition module is configured to obtain the conjugate of the reference signal of the current cell, then multiply with the pilot symbol of the signal-reduced received signal of the current cell to obtain a rough channel frequency-domain response with reference signal eliminated.

A rough channel time-domain impulse response acquisition module is configured to subject the rough channel frequency-domain response to IDFT to obtain a rough channel time-domain impulse response.

A rough single-user time-domain impulse response acquisition module is configured to subject the rough channel time-domain impulse response to multi-user separation and windows selection denoising to obtain a rough single-user time-domain impulse response.

A rough channel estimation result acquisition module is configured to subject the rough single-user time-domain impulse response to DFT to obtain the rough channel estimation result of each user.

A rough interference signal acquisition module is configured to subtract the rough channel estimation result of each user from the rough channel frequency-domain response to obtain the rough interference signal.

A precise interference signal acquisition module 4022 is configured to perform channel estimation on the rough interference signal according to a reference signal of the neighboring cell to obtain a precise interference signal.

Preferably, the precise interference signal acquisition module 4022 can include the following modules.

A precise channel frequency-domain response acquisition module is configured to obtain the conjugate of the reference signal of the neighboring cell, and then multiply with the rough interference signal to obtain a precise channel frequency-domain response with reference signal eliminated.

A precise channel time-domain impulse response acquisition module is configured to subject the precise channel frequency-domain response to IDFT to obtain a precise channel time-domain impulse response signal.

A precise single-user time-domain impulse response acquisition module is configured to subject the precise channel time-domain impulse response to multi-user separation and windows selection denoising to obtain a precise single-user time-domain impulse response.

A precise channel estimation result acquisition module is configured to subject the precise single-user time-domain impulse response to Fourier transform to obtain the precise channel estimation result of the neighboring cell.

A precise interference signal acquisition module is configured to subtract the precise channel estimation result of the neighboring cell from the rough interference signal to obtain the precise interference signal.

An interference rejection module 404 is configured to reject the precise interference signal.

Preferably, the interference rejection module 404 can include the following modules.

An interference detection module 4041 is configured to perform uplink IRC detection using the precise interference signal to obtain the detection result.

A precise interference rejection module 4042 is configured to reject the precise interference signal according to the detection result.

In conclusion, in the technical scheme of the application, before obtaining the interference signal, the received signal of the current cell is subjected to signal reduction. Estimate is made to interference using the signal with the received signal of the current cell reduced according to the scheduling information of the neighboring cell to obtain a precise interference signal, which has a better rejection effect to the uplink co-frequency interference of the neighboring cell.

The computer readable recording medium includes any mechanism which is configured to store or transfer information in the computer readable (such as a computer) form. For example, the machine-readable medium includes read-only memory (ROM), random access memory (RAM), disk memory medium, optical memory medium, flash memory medium, and electrical, optical, and acoustic or other forms of propagation signals (such as carrier, infrared signal and digital signal), and the like.

The device embodiments are simply described, because the device embodiments are basically similar to the method embodiments; descriptions of the method embodiments can be consulted for relevant descriptions of device embodiments.

Embodiments in the specifications are described in a progressive way. Emphases on the description of each embodiment are the part different from other embodiments. The same or similar parts of the embodiments can be referred to mutually.

Those skilled in the art can appreciate that all or part of steps according to the above methods can be implemented in hardware associated with the program instruction. The program can be stored in a computer readable storage medium, when the program executed, the steps according to method embodiments above are performed. The mentioned storage medium includes various mediums that can store program codes, such as ROM, RAM, disks, or optical disks and the like.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

1. A method for rejecting interference signal, comprising:
performing signal reduction on a received signal of a current cell;
performing channel estimation on the signal-reduced received signal of the current cell according to a reference signal of the current cell and a reference signal of a neighboring cell to obtain a precise interference signal; and
rejecting the precise interference signal.

2. The method of claim 1, wherein performing channel estimation on the signal-reduced received signal of the current cell according to the reference signal of the current cell and the reference signal of the neighboring cell to obtain the precise interference signal comprises:
performing channel estimation on the signal-reduced received signal of the current cell according to the reference signal of the current cell to obtain a rough interference signal; and
performing channel estimation on the rough interference signal according to the reference signal of the neighboring cell to obtain the precise interference signal.

3. The method of claim 2, wherein performing channel estimation on the signal-reduced received signal of the current cell according to the reference signal of the current cell to obtain the rough interference signal comprises:
obtaining the conjugate of the reference signal of the current cell, then multiplying with a pilot symbol of the signal-reduced received signal of the current cell to obtain a rough channel frequency-domain response with reference signal eliminated;
subjecting the rough channel frequency-domain response to inverse discrete Fourier transform to obtain a rough channel time-domain impulse response;
subjecting the rough channel time-domain impulse response to multi-user separation and windows selection denoising to obtain a rough single-user time-domain impulse response;
subjecting the rough single-user time-domain impulse response to discrete Fourier transform to obtain a rough channel estimation result of each user; and
subtracting the rough channel estimation result of each user from the rough channel frequency-domain response to obtain the rough interference signal.

4. The method of claim 3, wherein performing channel estimation on the rough interference signal according to the reference signal of the neighboring cell to obtain the precise interference signal comprises:
obtaining the conjugate of the reference signal of the neighboring cell, then multiplying with the rough interference signal to obtain a precise channel frequency-domain response with reference signal eliminated;
subjecting the precise channel frequency-domain response to inverse discrete Fourier transform to obtain a precise channel time-domain impulse response;
subjecting the precise channel time-domain impulse response to multi-user separation and windows selection denoising to obtain a precise single-user time-domain impulse response;
subjecting the precise single-user time-domain impulse response to Fourier transform to obtain a precise channel estimation result of the neighboring cell;
subtracting the precise channel estimation result of the neighboring cell from the rough interference signal to obtain the precise interference signal.

5. The method of claim 1, wherein rejecting the precise interference signal comprises:
performing uplink Interference Rejection Combining detection using the precise interference signal to obtain a detection result; and
rejecting the precise interference signal according to the detection result.

6. A device for rejecting interference signal, comprising:
a signal reduction module configured to perform signal reduction on a received signal of a current cell;
a channel estimation module configured to perform channel estimation on the signal-reduced received signal of the current cell according to a reference signal of the current cell and a reference signal of a neighboring cell to obtain a precise interference signal; and
an interference rejection module configured to reject the precise interference signal.

7. The device of claim 6, wherein the channel estimation module comprises:
a rough interference signal acquisition module configured to perform channel estimation on the signal-reduced received signal of the current cell according to the reference signal of the current cell to obtain a rough interference signal; and
a precise interference signal acquisition module configured to perform channel estimation on the rough interference signal according to the reference signal of the neighboring cell to obtain the precise interference signal.

8. The device of claim 7, wherein the rough interference signal acquisition module comprises:
a rough channel frequency-domain response acquisition module configured to obtain the conjugate of the reference signal of the current cell, then multiply with a pilot symbol of the signal-reduced received signal of the current cell to obtain a rough channel frequency-domain response with reference signal eliminated;
a rough channel time-domain impulse response acquisition module configured to subject the rough channel frequency-domain response to inverse discrete Fourier transform to obtain a rough channel time-domain impulse response;
a rough single-user time-domain impulse response acquisition module configured to subject the rough channel time-domain impulse response to multi-user separation and windows selection denoising to obtain a rough single-user time-domain impulse response;
a rough channel estimation result acquisition module configured to subject the rough single-user time-domain impulse response to discrete Fourier transform to obtain a rough channel estimation result of each user; and
a rough interference signal acquisition module configured to subtract the rough channel estimation result of each user from the rough channel frequency-domain response to obtain the rough interference signal.

9. The device of claim 8, wherein the precise interference signal acquisition module comprises:
a precise channel frequency-domain response acquisition module configured to obtain the conjugate of the reference signal of the neighboring cell, then multiply with the rough interference signal to obtain a precise channel frequency-domain response with reference signal eliminated;
a precise channel time-domain impulse response acquisition module configured to subject the precise channel frequency-domain response to inverse discrete Fourier transform to obtain a precise channel time-domain impulse response;
a precise single-user time-domain impulse response acquisition module configured to subject the precise channel time-domain impulse response to multi-user separation and windows selection denoising to obtain a precise single-user time-domain impulse response;
a precise channel estimation result acquisition module configured to subject the precise single-user time-domain impulse response to Fourier transform to obtain a precise channel estimation result of the neighboring cell; and
a precise interference signal acquisition module configured to subtract the precise channel estimation result of the neighboring cell from the rough interference signal to obtain the precise interference signal.

10. The device of claim 6, wherein the interference rejection module comprises:
an interference detection module configured to perform uplink Interference Rejection Combining detection using the precise interference signal to obtain a detection result; and
a precise interference rejection module configured to reject the precise interference signal according to the detection result.

11. A computer readable recording medium for recording a program for performing the method of claim 1.
